(19) United States
(12) Patent Application Publication
(10) Pub. No.: US 2018/0213961 A1
(43) Pub. Date: Aug. 2, 2018

(54) Manually Activated Fruit Press

(71) Applicant: keeeper GmbH, Stemwede (DE)

(72) Inventors: Alex Dumler, Hamburg (DE); Florian M. Witt, Wentorf (DE); Johanna Königsberger, Hamburg (DE); Matthias Hecker, Hamburg (DE); Thorsten Plate, Hamburg (DE); Andrew Ferrier, Ottawa (CA)

(21) Appl. No.: 15/885,861

(22) Filed: Feb. 1, 2018

(30) Foreign Application Priority Data
Feb. 2, 2017 (EP) 17 154 470.3

(51) Int. Cl. A47J 19/00; A47J 19/02

(52) U.S. Cl. CPC A47J 19/005; A47J 19/022

(57) ABSTRACT

A manual fruit press has first and second lever arms and a joint connecting first ends of the lever arms to each other. The second ends of the lever arms opposite the joint have handgrip pieces. The first lever arm has a cup-shaped depression forming a strainer with support block and arranged between handgrip piece and joint. The second lever arm has a press element as an integrated molded component thereof. The press element is a cup-shaped depression projecting downward beyond the handgrip piece of the second lever arm. The press element, when the first and second lever arms are moved toward each other, is lowered toward the support block of the strainer and exerts pressure on a piece of fruit inserted into the pressing chamber between strainer and press element. A collection cup is releasably connected below the strainer to the first lever arm or the strainer.

### BACKGROUND OF THE INVENTION

The present invention relates to a manually activated fruit press having a first and a second lever arm which are interconnected by a joint, wherein the joint is disposed at one end of the lever arms. The lever arms on the ends thereof that face away from the joint have in each case one handgrip piece. A strainer, disposed between the handgrip piece and the joint, having an associated support block and a collection cup disposed therebelow, is connected to the first lever arm. The second lever arm is connected to a press element which in a converging movement of the two lever arms exerts pressure on a piece of fruit that is inserted into a pressing chamber that is configured between the strainer, having the associated support block, and the press element. The strainer including the associated support block is connected directly to the first lever arm. The collection cup is disposed below the strainer and is releasably connected to the first strainer including the associated support block and/or to the first lever arm.

A fruit press of the generic type is known from document DE 101 28 693 A1. The strainer is configured in an elevation of the lower handgrip part. Juice that exits from a fruit can readily run off toward the side. A fruit which bears on the elevation can readily slide off toward the side. A further fruit press of the generic type can be derived from document U.S. Pat. No. 1,542,322. The multiple-part construction of the fruit press by way of a plurality of joints is complex in terms of production and handling.

A further fruit press is known from document DE 34 14 873 A1. The fruit press disclosed therein has a press ram that is connected in articulated manner to the upper lever arm. The lower lever arm is rigidly connected to a container into which a strainer insert is placed. The fruit press can be operated with one hand. The strainer insert as a component part has a support block which here is configured as a bulged base and in turn has strainer openings through which squeezed fruit juice can run off. When the two lever arms are moved toward one another from an open position, the press ram here in is moved into the container and onto the strainer insert having the associated support block. If a piece of fruit has previously been placed onto the support block, fruit juice is squeezed from the piece of fruit in the course of this movement. The comparatively coarse fruit components that are released herein are retained by the strainer webs, while the liquid fruit juice can run off through the strainer openings into the container that is located therebelow.

The removal of the squeezed fruit juice in the case of this fruit press is overall very complex. The strainer insert having the associated support block can be removed from the container only once the lever arms have been opened so wide that the press ram herein has been moved out of the container. In order to be able to empty the container, the strainer insert having the support block has first to be removed from the container since the strained fruit juice when poured out would otherwise conjointly flush out the comparatively coarse fruit components that have been retained in the strainer. The lever arm that is rigidly connected to the container is very poorly manipulable when pouring. The movable press ram also interferes in the handling of the fruit press. Handling overall is thus very complex.

It is the object of the present invention to modify the fruit press such that the fruit press is easier to handle.

### SUMMARY OF THE INVENTION

The object in a fruit press of the generic type is achieved in that the strainer including the associated support block is configured in a cup-type depression in the first lever arm, the press element forms an integrated component part of the integral molded body of the second lever arm, and the press element is embodied as a cup-type depression in the second lever arm. The depression is projecting downward beyond the lower side of the second lever arm and in a mutual closing movement of the first and of the second lever arms is lowered toward the support block.

On account of the direct connection of the strainer including the associated support block to the first lever arm, the strainer no longer has to be first removed from the collection cup before the squeezed juice can be poured out of the collection cup. Rather, the strainer having the support block can now remain connected to the first lever arm and thus to the entire fruit press when a user wants to use the squeezed fruit juice that has been strained by the strainer. To this end, the collection cup can now be removed immediately and easily without further additional handgrips from the fruit press and be kept separately from the remaining fruit press. The remaining poorly manipulable fruit press can be put aside after the collection cup has been removed, when the fruit juice harvested is being transferred. The compact collection cup having the fruit juice accumulated therein permits much simpler and more precise handling than the voluminous fruit press, in particularly when cooking when only a little amount of lemon juice is required in order to refine the taste of a meal, for example.

The fruit press can now selectively also be used without the collection cup being connected to the fruit press in the pressing procedure. When the lever arms are pressed together, the fruit juice that exits from the squeezed piece of fruit can trip directly from the strainer into a separate glass or into a bowl that is located below the strainer, or the drops of fruit juice are directly drizzled onto a foodstuff that is to be refined with the fruit juice. The drizzled quantity can be observed and meted very accurately by setting the current pressing pressure to the specific requirement for juice. This additional use potential widens the application spectrum of the fruit press and additionally simplifies handling.

In terms of the invention there is no significant difference as to whether the collection cup is connected only to the first strainer and/or to the lever arm. It is essential that the collection cup can be easily released from the components of the remaining fruit press and thereafter can be handled independently of the fruit press.

The strainer has a plurality of material webs, discharge openings through which fruit juice that is squeezed from a piece of fruit can run out of the pressing chamber that is located between the press element and the strainer being located between the material webs. A support block onto which a piece of fruit can be placed prior to the pressing procedure is also part of the strainer. The support block can be designed as a bulging spatial element which protrudes at least beyond the lowermost strainer openings. An annular space which is capable of receiving pieces of rinds of a squeezed piece of fruit, for example, can be configured between the support block and the side wall of the pressing chamber. The support block in turn can have strainer openings. The surface of the support block can be configured so as to be smooth or so as to have groove-type depressions through which squeezed fruit juice can run off in the direction of the discharge openings.

The arrangement of the collection cup below the strainer means that the collection cup in the dripping direction of the fruit juice that runs out of the strainer is disposed below the strainer.

The releasable connection of the collection cup to the first lever arm refers to a connection in which the collection cup is connected in a sufficiently fixed manner to the first lever arm so as to not be released in a self-acting manner from the first lever arm when fruit juice runs into the collection cup when in use, on the one hand, but also so as to be able to be readily released from the first lever arm such that no fruit juice is spilt when the collection cup is consciously separated from the first lever arm, on the other hand. A suitable releasable connection could have, for example, a bayonet fastener, a latching fastener mechanism, a lever or clamp closure mechanism, a catch, and/or a short screw thread.

The strainer including the associated support block is configured in a cup-type depression in the first lever arm. The cup-type depression forms a receptacle space into which the piece of fruit to be squeezed can be placed. The sidewalls of the cup-type depression are closed so as to form a lateral delimitation of the pressing chamber which likewise lies in the cup-type depression. The cup-type depression projects from the lower side of the first lever arm. On account thereof, the lever stroke of the second lever arm that is required in order for both handgrip pieces of the lever arms to be able to be gripped with one hand can be shortened.

The press element forms an integrated component part of the integral molded body of the second lever arm. It is indeed also possible for the press element to be configured as a separate molded part which is connected releasably or fixedly to the second lever arm. However, in functional terms, it is not mandatory for the second lever arm to be a component that is separate from the press element. The press element shape of the press element can be readily integrated in the shape of the second lever arm. This is readily possible in particular when the second lever arm is a molded part that is produced from a plastics material. The tool by which the second lever arm is produced herein can be designed such that the negative molds by way of which the press element as a shape is configured as an integral integrated component part of the second lever arm are contained in the tool. On account thereof, additional assembly steps are disposed with, the press element is captively connected to the second lever arm, and cleaning and handling of the fruit press is substantially simplified on account of the lower number of parts.

The press element is configured as a cup-type depression in the second lever arm, the depression projecting downward beyond the lower side of the second lever arm and in a mutual closing movement of the first and of the second lever arm being lowered toward the support block. In the case of this design embodiment, the press element can be readily observed in the closing procedure. When the cup-type depression that forms the press element in terms of the dimensions and the shape of the depression corresponds to the cup-type depression that forms the support block, the handgrip ends in the terminal position thereof can touch one another in a pressing procedure such that the mutual lever stroke that has to be performed by both lever arms in a pressing procedure remains as short as possible.

According to one design embodiment of the invention, the strainer including the associated support block forms an integrated component part of the integral molded body of the first lever arm. It is indeed also possible for the strainer having the support block to also be configured as a separate molded part which is connected releasably or fixedly to the first lever arm. However, in functional terms it is not mandatory for the strainer having the associated support block to be a component that is separate from the first lever arm. The strainer shape of the strainer can be readily integrated in the shape of the first lever arm. This is readily possible in particular when the first lever arm is a molded part that is produced from a plastics material. The tool by which the first lever arm is produced herein can be designed such that the negative molds by way of which the strainer having the support block as a shape is configured as an integral integrated component part of the first lever arm are contained in the tool. On account thereof, additional assembly steps are disposed with, the strainer is captively connected to the first lever arm, and cleaning and handling of the fruit press is substantially simplified on account of the lower number of parts.

According to one design embodiment of the invention, the press element has a pressing face which at least on part of the external circumference thereof is protruded beyond downward by one or a plurality of support elements. The support element or the support elements form a type of skirt which in the case of a mutual closing movement of the first and of the second lever arms at least partially reduces or completely covers the gap on the circumference between the space above the support block and the press element, the gap becoming increasingly smaller during the closing movement. On account of the support element or the support elements, a piece of fruit that is placed into the pressing chamber is in particular prevented from swelling out laterally from the pressing chamber. Conjointly with the downward movement of the press element, the piece of fruit is also directed downward by the support elements, on account of which the piece of fruit remains so as to be held on the support block. Fruit juice which in pressing splashes out of squashed cells can also no longer splash without impediment from the pressing chamber in an upward and lateral manner, but is caught by the support elements and runs downward into the region of the strainer openings.

According to one design embodiment of the invention, the handgrip pieces of the lever arms on mutually neighboring edge regions have a chamfer. It is prevented on account of the chamfers that the skin can be jammed between the edges when the two lever arms are pressed onto one another.

According to one design embodiment of the invention, a pouring lip is configured on the collection cup. The fruit juice that has accumulated in the collection cup can be cleanly poured without spillage on account of the pouring lip.

According to one design embodiment of the invention, the collection cup by way of a pouring lip is dischargeable also in the assembled state. In the case of this design embodiment, the collection cup does not have to be disassembled from the fruit press in order for the squeezed fruit juice to be able to be emptied from the collection cup. Rather, it is sufficient for the fruit press to be rotated by a few angular degrees about the horizontal longitudinal axis of the fruit press in order to allow the fruit juice to run out of the collection cup by way of the pouring lip in the oblique position achieved on account thereof. The comparatively solid fruit components herein are retained by the strainer and cannot leave the pressing chamber. The handling of the fruit press is yet again significantly simplified on account thereof.

According to one design embodiment of the invention, a removal tab that projects laterally beyond the upper periphery of the collection cup is configured on the collection cup. The collection cup can be more easily pulled away from the fruit press by way of the removal tab. The removal tab also concentrates the tensile force that is applied in the removal toward a force engagement point in relation to which the latching, catching, or locking elements can be precisely conceived.

According to one design embodiment of the invention, a placing face onto which the fruit press when not in use is placeable is configured on the lower side of the collection cup. The placing face herein is dimensioned and placed such that the fruit press stands firmly thereon. To this end, the position and size of the placing face has to be adapted to the center of gravity of the fruit press, or the components of the fruit press in terms of weight are mutually adapted such that the center of gravity is positioned so as to match the position and size of the placing face, respectively.

It is to be explicitly pointed out that, to the extent that no technically inhibiting obstacles exist, each of the design embodiments of the invention that have been described above can be combined with the subject matter of the main claim individually but also in any arbitrary combination with another design embodiment.

Further modifications and design embodiments of the invention can be derived from the description of the subject matter hereunder and from the drawings.

### BRIEF DESCRIPTION OF THE DRAWINGS

The invention is now to be described in more detail by means of an exemplary embodiment.

FIG. 1 shows a view from obliquely above onto a fruit press.

FIG. 2 shows a view from obliquely below onto a fruit press having a collection cup received thereon.

FIG. 3 shows a sectional view of a closed fruit press.

FIG. 4 shows a sectional view of an opened fruit press having a lemon placed therein.

### DESCRIPTION OF PREFERRED EMBODIMENTS

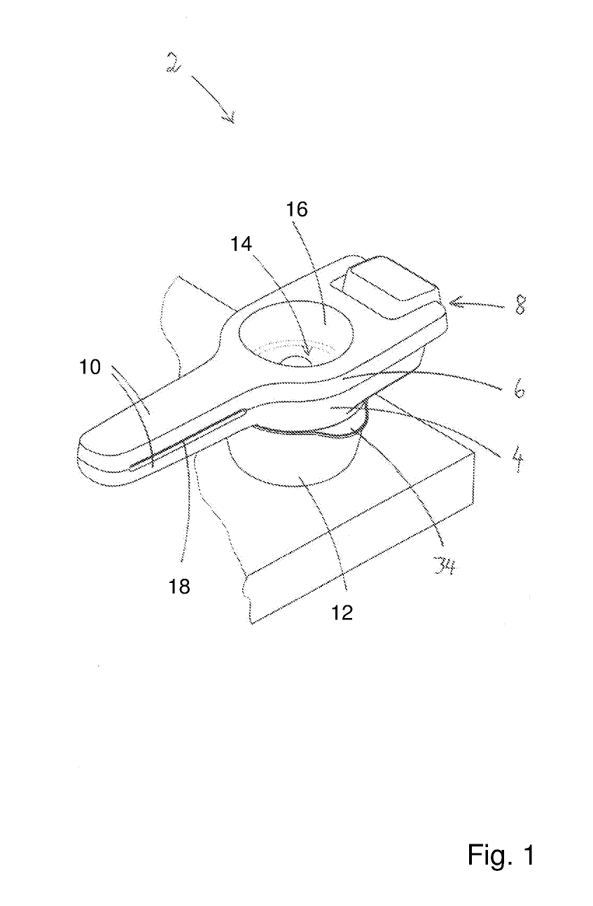

A fruit press 2 is shown in a view from obliquely above in FIG. 1. The fruit press 2 has a first lever arm 4 and a second lever arm 6. Both lever arms 4, 6 at a respective end are interconnected by way of a joint 8. The two lever arms 4, 6 at ends that face away from the joint 8 have in each case one handgrip piece 10 by way of which the fruit press 2 can be held. The fruit press 2 is shown in a closed position in FIG. 1. When the fruit press 2 is to be opened in order for a piece of fruit to be placed therein, only the second lever arm 6, or only the first lever arm 4, or both lever arms 4, 6 simultaneously, is/are pivoted so as to open about the joint 8.

A collection cup 12 is located on the lower side on the first lever arm 4. The collection cup 12 is releasable from the first lever arm 4. Releasing can be performed, for example, in that the removal tab 34 is pulled.

A cup-type depression 16 can be seen in the second lever arm 6, the base of the depression 16 configuring the press element 14. In a pivoting movement of the second lever arm 6 about the joint 8 toward the first lever arm 4, the press element 14 is also moved downward. A piece of fruit that is located below the press element 14 herein is compressed such that fruit juice exits from the piece of fruit placed therein. Of course, the first lever arm 4 can also be moved toward the second lever arm 6, or both lever arms are simultaneously moved toward one another, the same effect being achieved thereby.

It can moreover be seen in the view shown in FIG. 1 that the handgrip pieces 10 of the lever arms 4, 6 on mutually neighboring edge regions have in each case one chamfer 18.

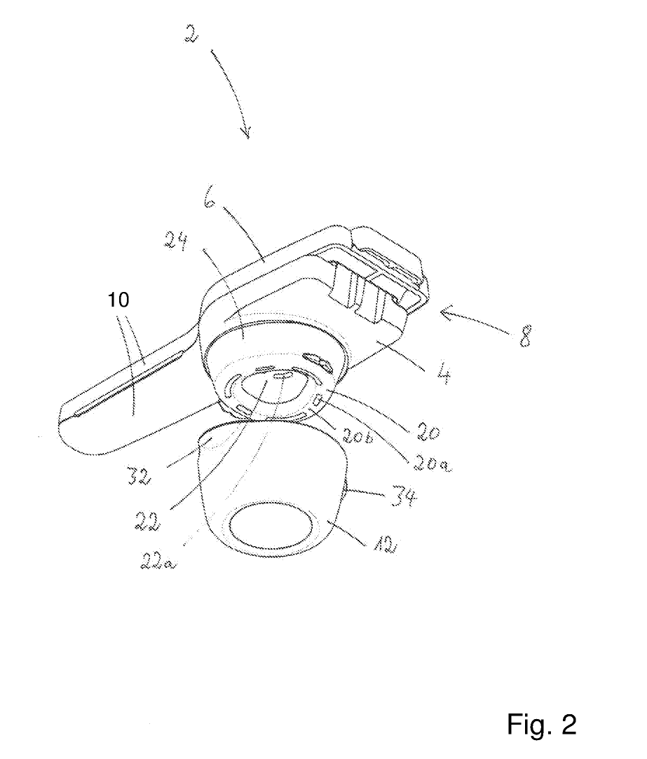

The fruit press 2 is shown in a view from obliquely below in FIG. 2, wherein the collection cup 12 therein is removed from the fruit press. The strainer 20 can be seen in the view from obliquely below, the strainer 20 having a number of strainer openings 20a. Material webs 20b which retain the comparatively coarse fruit particles in the cup-type depression 24 are located between the strainer holes 20a.

The support block 22 as a type of hump onto which a piece of fruit can be placed rises in the central region of the strainer 20. The support block 22 in the exemplary embodiment also has strainer holes 22a. It can be seen in the view illustrated in FIG. 2 that the cup-type depression 24 projects downwards beyond the first lever arm 4.

The pouring lip 32 and the removal tab 34 can be seen on the collection cup 12.

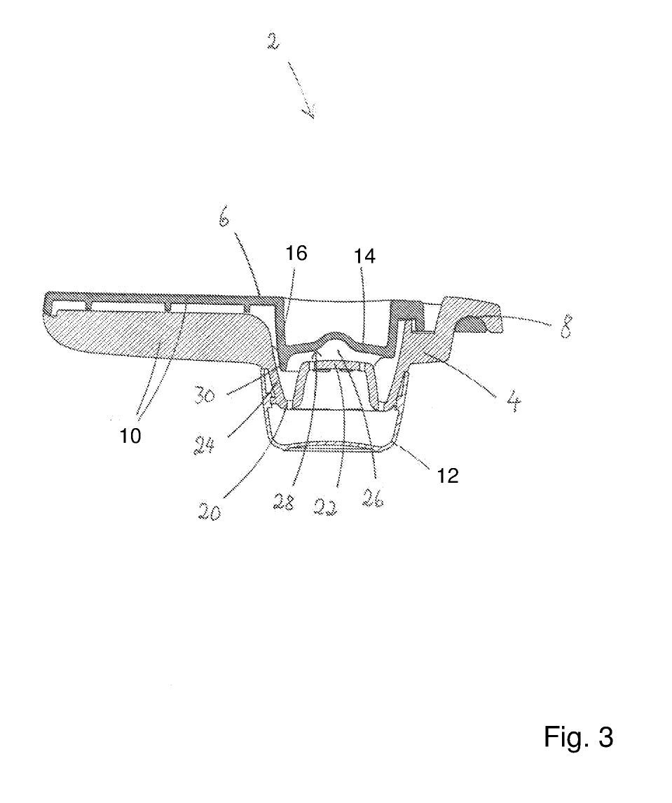

A sectional view of a closed fruit press is shown in FIG. 3. The pressing chamber 26 can be readily seen in the sectional view. The pressing chamber 26 is upwardly delimited by the press element 14 and downwardly by the support block 22 in the central region. The pressing chamber 26 at the sides of the support block 22 extends right down to the strainer 20. The pressing chamber 26 is laterally delimited by the side wall of the cup-type depression 24.

It can be seen in the sectional drawing in FIG. 3 that a vacant space in which the remaining pulp can accumulate after a piece of fruit has been squeezed remains between the pressing face 26 of the press element 14 and the upper side of the support block 22 even in the completely closed position of the two lever arms 4, 6. The vacant space enables the two handgrip pieces 10 to be placed on top of one another in the terminal position of a pressing procedure without the remaining pulp being squashed herein and reaching the region of the strainer openings, the latter being potentially clogged on account thereof.

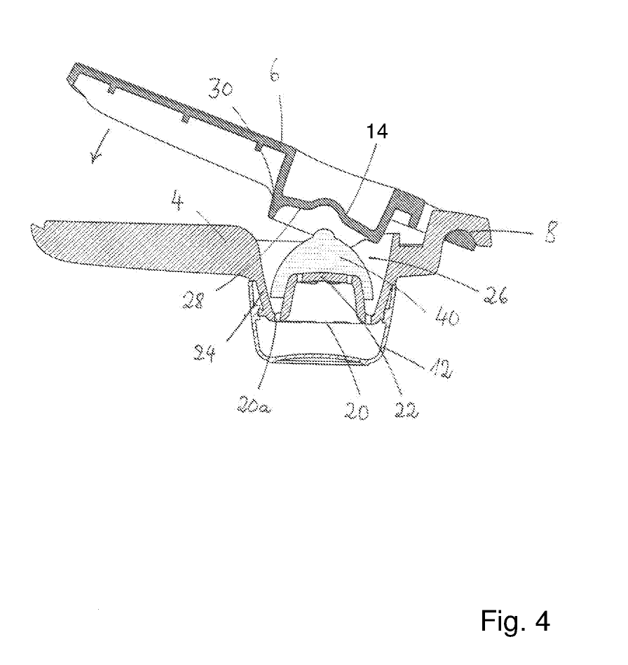

The support element 30 can moreover readily be seen in the sectional view in FIGS. 3 and 4, the support element 30 projecting downward beyond the neighboring pressing face 28. The support element 30 in the exemplary embodiment also ranges about the pressing face 28 of the press element 14 by a comparatively large angular range.

It can be furthermore seen in this sectional view in FIG. 3 that the collection cup 12 is held on the first lever arm 4 by way of respective latching cams. The collection cup 12 can be removed in a downward manner when the external wall of the collection cup 12 at the side of the hand grips is lifted beyond the latching cam that is configured on the external side of the side wall.

A placing face onto which the fruit press when not in use can be placed is configured on the lower side of the collection cup 12. The fruit press 2 is balanced such that the fruit press 2 can stand on the placing face without falling over.

It can moreover be seen in the sectional view in FIG. 3 that the collection space of the collection cup 12 is dimensioned sufficiently in order for a quantity of fruit juice from the pressing chamber 26 to be received. The sidewalls of the collection cup 12 are constructed so as to be so high that the sidewalls in the assembled position of the collection cup 12 in an upward manner protrude significantly beyond the strainer openings 20. Overflowing of the collection cup 12 during a pressing procedure and spilling of the fruit juice that has accumulated in the collection cup 12 after pressing and when removing the collection cup 12 from the fruit press 2 is avoided on account thereof.

The fruit press 2 that in FIG. 3 is illustrated in a sectional drawing is shown in an opened position in FIG. 4, wherein a lemon 40 has been placed in the pressing chamber 26. It can be understood that the lemon 40 in a closing movement of the second lever arm 6 in the direction indicated by the arrow is pressed by the pressing face 28 of the press element 14 onto the support block 22. Herein, the juice that is contained in the flesh of the lemon 40 can run off along the support block 22 downward into the strainer openings 20a and from there drip into the collection cup 12. It can also be seen in the semi-open position of the second lever arm 6 that the support element 30 has the effect of a good splash guard in the subsequent pressing procedure.

The invention is not limited to the exemplary embodiment above. A person skilled in the art will have no difficulties in modifying the exemplary embodiment in a manner that appears suitable to the person skilled in the art in order for the exemplary embodiment to be adapted to a specific type of application.

The specification incorporates by reference the entire disclosure of European priority document 17 154 470.3 having a priority filing date of Feb. 2, 2017.

While specific embodiments of the invention have been shown and described in detail to illustrate the inventive principles, it will be understood that the invention may be embodied otherwise without departing from such principles.

What is claimed is:

1. A manually activated fruit press (2), comprising:
a first lever arm (4) comprising a first end and an opposed second end;
a second lever arm (6) comprising a first end and an opposed second end;
a joint (8) connecting the first end of the first lever arm (4) and the first end of the second lever arm (6) to each other;
the second end of the first lever arm (4) comprising a first handgrip piece (10) and the second end of the second lever arm (6) comprising a second handgrip piece (10);
the first lever arm (4) comprising a cup-shaped depression (24) and the cup-shaped depression forms a strainer (20) comprising a support block (22), wherein the cup-shaped depression (24) is arranged between the first handgrip piece (10) and the joint (8);
the second lever arm (6) comprising a press element (14) as an integrated component part of an integral molded body of the second lever arm (6), wherein the press element (14) is a cup-shaped depression (16) formed in the second lever arm (6), wherein the depression (16) projects downward beyond a lower side of the second handgrip piece (10) of the second lever arm (6), wherein the press element (14), when the first and second lever arms (4, 6) are moved toward each other by a mutual closing movement, is lowered toward the support block (22) of the strainer (20) and is configured to exert a pressure on a piece of fruit inserted into a pressing chamber (24) formed by the strainer (20) and the press element (14);
a collection cup (12) disposed below the strainer (20) and releasably connected to the first lever arm (4) or the strainer (20)

2. The fruit press (2) according to claim 1, wherein the strainer (20) with the support block (22) forms an integrated component part of an integral molded body of the first lever arm (4).

3. The fruit press (2) according to claim 1, wherein the press element (14) comprises a pressing face facing the strainer (20) and further comprises an external circumference, wherein at least a part of the external circumference comprises one or a plurality of support elements (30) that project downward beyond the pressing face (28).

4. The fruit press (2) according to claim 1, wherein the first and second handgrip pieces (10) have mutual neighboring edge regions provided with a chamfer (18), respectively.

5. The fruit press (2) according to claim 1, wherein the collection cup comprise a pouring lip (32).

6. The fruit press (2) according to claim 5, wherein the collection cup (12) is configured such that a contents collected therein is dischargeable via the pouring lip (32) when the collecting cup (12) is connected to the first lever arm (4) or the strainer (20).

7. The fruit press (2) according to claim 1, wherein the collecting cup comprises a removal tab (34) that projects laterally beyond an upper periphery of the collection cup (12).

8. The fruit press (2) according to claim 1, wherein the collection cup comprises a lower side with a placing face configured to support the fruit press when not in use.
